(19) United States
(12) Patent Application Publication
(10) Pub. No.: US 2025/0238654 A1
(43) Pub. Date: Jul. 24, 2025

(54) Data Schema for Hyper Ingestion in Data Lake Environment

(71) Applicant: Bank of America Corporation, Charlotte, NC (US)

(72) Inventors: Imran Khan, Uttar Pradesh (IN); Dhuvaraga Prasath B, Tamil Nadu (IN); Vinod Maghnani, Haryana (IN); Shailendra Singh, Maharashtra (IN)

(21) Appl. No.: 18/416,584

(22) Filed: Jan. 18, 2024

(51) Int. Cl. G06N 3/042

(52) U.S. Cl. CPC G06N 3/042

(57) ABSTRACT

Systems and processes are disclosed for processing and integrating multinational data into data lakes. Utilizing a generative AI engine, data schema templates can be dynamically generated to standardize diverse data streams from various sources. The systems and processes incorporate edge computing for localized preprocessing, ensuring data quality and compliance with international regulations. Innovative features include real-time data routing and prioritization algorithms for efficient hyper-ingestion, and an embedded livestream for instantaneous business decision-making. The disclosed cutting-edge approaches address the complexities of modern data integration challenges.

### TECHNICAL FIELD

The present disclosure relates to data processing and artificial intelligence. More particularly, this disclosure relates to computational processes or apparatus for decision making, problem-solving, or pattern recognition under the guidance of a heuristic or an algorithm that simulates a cognitive process as it relates to generative AI utilized in conjunction with edge computing infrastructure, network topology, and synchronization mechanisms to ensure accurate and timely data processing across the distributed edge computing environment.

### DESCRIPTION OF THE RELATED ART

The problem addressed by this disclosure revolves around managing and standardizing large-scale, multinational data in a data lake. This involves addressing the complexity of diverse data formats, languages, and regulatory compliance requirements from various countries. The challenge is not only to ingest this varied data efficiently but also to ensure it is processed, standardized, and secured in a way that complies with different national regulations, while still being accessible and useful for quick, data-driven decision-making in a global business context.

Addressing the complexities involved in hyper-ingestion of multinational data into data lakes, the problem presents multiple issues that need to be resolved.

One issue is diverse data formats and standards. Organizations face the challenge of integrating data from various sources, each with unique formats and standards. This diversity necessitates a flexible yet robust system for data ingestion and standardization, ensuring that all data, regardless of its original format, is uniformly structured for analysis and storage.

Another is multilingual and cultural differences. Dealing with data from different countries introduces the issue of multiple languages and cultural contexts. This not only impacts the data's interpretation but also its relevance and applicability in different markets. Overcoming language barriers and ensuring cultural appropriateness is crucial for effective data utilization.

Another issue is regulatory compliance and data sovereignty. Each country has specific regulations regarding data privacy, security, and usage. Navigating this legal maze is vital for multinational operations, requiring compliance with local laws in each jurisdiction. Data sovereignty becomes a critical factor, demanding a nuanced approach to data storage and processing.

A further issue is real-time processing for decision making. The velocity at which data is generated and the need for immediate insights necessitate real-time data processing capabilities. This demands a high-performance system capable of handling large volumes of data swiftly and efficiently, turning raw data into actionable intelligence promptly.

Another relates to scalability and efficiency. As data volumes grow exponentially, the system must be scalable, capable of handling increased loads without compromising performance. Efficiency in data processing not only saves time but also reduces operational costs, making scalability a key factor in managing data lakes.

Yet another issue relates to security and privacy concerns. In a world where data breaches are common, ensuring the security and privacy of data is paramount. This involves implementing robust security protocols and encryption processes to protect sensitive information from unauthorized access and cyber threats. Data privacy is not just a regulatory requirement but also a matter of trust and reputation for organizations.

Hence there is a long felt and unsatisfied need to provide a solution that integrates generative AI with edge computing and network structures, employing synchronization processes for precise, real-time data handling within the distributed edge network.

### SUMMARY OF THE INVENTION

In accordance with one or more arrangements of the non-limiting sample disclosures contained herein, solutions are provided to address one or more of the above issues and problems by, inter alia, innovatively combining generative artificial intelligence (AI) with edge computing infrastructure to optimize data processing across a distributed network. Utilizing advanced AI algorithms, such as GPT and Transformer, the system autonomously generates and standardizes data schema templates for hyper ingestion into data lakes, taking into account the data's source, regional context, and the nuances of the edge network.

More specifically, the disclosures contained herein relate a data processing architecture using generative artificial intelligence (AI) and edge computing. This complex system is designed to optimize data processing across distributed networks by creating standardized data schema templates for hyper ingestion into data lakes.

Exemplary features and processes described herein include: 1. Generative AI and Edge Computing Integration (Utilizing AI algorithms like GPT and Transformer for generating data schema templates); 2. Multinational Data Preprocessing and Standardization (Preprocessing data from various edge servers, including challenging data from mergers and acquisitions, which involves language-independent processing and adhering to international regulations); 3. Edge-Based Data Routing and Prioritization (Utilizing sophisticated algorithms to prioritize data for hyper ingestion, facilitating real-time decision-making for business users); 4. Merger and Acquisition Data Processing (Integrating acquisition data dynamically and ensuring seamless data continuity during organizational changes); 5. Advanced Security Measures (Adapting security protocols, including encryption and decryption, to comply with various international regulations); 6. Quality of Service Configuration (Employing a dynamic Quality of Service (QOS) configuration with a hybrid probability approach for data prioritization); 7. Localized Data Processing and Validation (Implementing edge-based techniques for international datasets, including data cleansing, deduplication, and quality checks); 8. AI-Driven Framework (For attribute recognition and compliance frameworks, along with the automated normalization of data schemas); 9. Dynamic Standardization Rules (Adjusting to contextual information to ensure data integrity across different databases); 10. Real-Time Data Integration Framework (For instant data enrichment and dynamic metadata ingestion in the context of mergers and acquisitions); and 11. AI-Enabled Hyper Ingestion and Live Streaming (Facilitating efficient data processing and providing live summarization of key moments for user live streams).

Additional highlights in different aspects of this disclosure include: 1. Generative AI Engine (which autonomously generates data schema templates, and leverages advanced algorithms like GPT and Transformer to analyze source data, optimizing data ingestion into data lakes); 2. Multifaceted Data Processing (The system processes data from various geographical locations, handling different languages, compliance standards, and data formats, with an emphasis on multinational standardization); 3. Edge Computing Infrastructure (utilizes edge-based processing, enabling data cleansing, deduplication, and preprocessing close to the data's origin to reduce latency and improve data quality); 4. Dynamic Data Schema Templates (The AI engine creates customized templates for data ingestion, considering factors like data type, frequency, storage consumption, and computing capabilities, wherein the templates are adaptable to different data sources and formats); 5. Merger and Acquisition (M&A) Data Integration (The system dynamically integrates M&A data, ensuring continuity and consistency with existing organizational data structures); 6. Efficient Data Routing and Prioritization (utilizing edge-based routing algorithms and hybrid geo-fencing, the system efficiently manages data flow, emphasizing energy-efficient routing and prioritizing data based on urgency and relevance); 7. Live Streaming and Real-Time Insights (The system enhances decision-making by providing live streaming data reports, offering business users timely insights); and 8. Training of the Generative AI Engine (The AI engine requires training with diverse source data sets to effectively generate and refine schema templates for varied data inputs).

This solves significant challenges in data processing, especially in environments with diverse and voluminous data sources. By standardizing data ingestion and leveraging AI for optimization, the system offers a novel solution for managing complex data landscapes efficiently and effectively. Further, the disclosures contained herein represent a comprehensive and advanced approach to managing and processing data in a distributed network environment, emphasizing efficiency, security, and adaptability to various data types and sources. It is particularly relevant in the context of large-scale, multinational data operations and mergers and acquisitions.

In practical application, multinational data from various edge servers is preprocessed and forwarded to a designated edge device. This includes optional data from mergers and acquisitions, which is particularly challenging to standardize. The edge device then executes further processing based on predefined rules and a language-independent model, outputting standardized data. This data feeds into an edge-based routing system, which prioritizes it using sophisticated algorithms to assign priority scores.

Enabled by these priority scores, hyper ingestion is activated, producing data reports. These reports are enhanced with real-time live streaming capabilities, empowering business users to make faster decisions.

Among the inventive features, various aspects of the disclosure provide an intelligent edge-based data merger system tailored for integrating acquisition data dynamically, ensuring seamless data continuity during organizational changes. It also adapts its security measures, including encryption and decryption, to comply with various international regulations automatically. The routing algorithms are not only futuristic and customized but also employ a dynamic Quality of Service (QOS) configuration that uses a hybrid probability approach for data prioritization, ensuring optimized data handling across the board.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, input data preprocessing for this disclosure involves several edge-based techniques tailored to international data sets. Data cleansing occurs near the data's origin, enhancing quality and reducing latency. An adaptive deduplication algorithm modifies its approach based on variable factors. Geolocation techniques optimize preprocessing for each country's data traits. Localized quality checks at the edge ensure data integrity, while a network of edge servers globally validates data quality across multiple countries.

In some arrangements, the multinational data standardization process of this disclosure involves transforming preprocessed data into a standardized, language-independent format with encryption, compliant with country-specific regulations. It includes machine translation for multilingual data, an AI-driven framework for attribute recognition, localized compliance frameworks for data security, and automated normalization of data schemas. Additionally, dynamic standardization rules adjust to contextual information, ensuring data integrity across different databases.

In some arrangements, merger and acquisition (M&A) data preprocessing in this disclosure ensures dynamic integration with an organization's existing data structures. This includes a real-time data integration framework, instant data enrichment for non-conforming M&A data, and dynamic metadata ingestion and mapping into the organization's metadata systems, facilitating seamless tracking and merging of M&A data during the merger process.

In some arrangements, edge-based data routing in this disclosure leverages generative AI for efficient hyper ingestion. Key features include a hybrid geo-fencing algorithm for energy-efficient routing, AI-driven collaborative prioritization among edge devices, personalized hyper ingestion tailored to user interactions, an adaptive AI infrastructure for scalability, and live summarization of key moments for user livestreams. These components work in synergy to optimize data flow and user experience.

In some arrangements, a generative AI engine generates data schema templates for hyper ingestion in a data lake environment. This addresses the challenge faced by organizations with customers from multiple countries, where data is collected in different languages, formats, and compliance requirements. The generative AI engine analyzes the source data and generates a schema for data ingestion into the data lake. The schema includes configurations for data storage format, security, data governance, metadata tagging, data transformation, and enrichment. The engine also considers factors like data type, ingestion frequency, storage consumption, and computing capability to optimize the data ingestion process. The generated schema templates can be customized for different sources and applied to ensure the data is ingested into the data lake in a structured and secure manner. The generative AI engine can be trained with a set of source data to converge on the appropriate schema. The foregoing reduces the effort and time required for developing data schema templates when onboarding new businesses to the data lake platform.

In some arrangements, a computer-implemented process for optimizing data processing in a distributed network environment for a data lake system may comprise one or more steps such as, for example, receiving multinational data at a plurality of edge servers from various geographical locations, wherein each edge server is configured with a local data processing unit capable of performing real-time data validation and quality checks; implementing distributed data cleansing at each edge server, wherein the data cleansing is adapted to local data characteristics of the respective geographical location and includes adaptive filtering techniques based on data type and source, and removing redundant data entries based on unique digital fingerprints of each data item; performing data deduplication at each edge server using algorithms tailored to the specific characteristics of the data from its geographical location, including fingerprinting techniques, delta encoding process, and configurable settings for deduplication aggressiveness based on data density and duplication patterns; standardizing the preprocessed data for language independence and regional compliance by applying machine translation and AI-driven attribute recognition capabilities, wherein the machine translation is executed using a neural network-based translation model capable of handling multiple languages; utilizing a generative artificial intelligence (AI) engine, communicatively connected to the edge servers, to autonomously generate data schema templates based on the standardized data, wherein the generative AI engine includes advanced algorithms like GPT and Transformer and is further configured to continuously learn and adapt its data schema generation process based on feedback from the data lake ingestion results; dynamically integrating data from mergers and acquisitions using a merger and acquisition data integration module with a data mapping tool that aligns divergent data formats and schemas from different entities, and performing real-time data integration and instant data enrichment for non-conforming data; implementing edge-based routing and prioritization algorithms using a machine learning algorithm to optimize data flow based on network conditions, historical data traffic patterns, and a hybrid geo-fencing system for efficient data management; facilitating hyper ingestion of the prioritized and standardized data into the data lake environment using a hyper ingestion module with a load balancing feature, wherein the hyper ingestion is continuously optimized based on live data characteristics and includes a feedback mechanism that updates and refines the data schema templates based on performance metrics; providing live streaming data reports to business users based on the hyper ingested data through a live data reporting interface offering customizable dashboards, enabling real-time insights and decision-making; and encrypting data during transmission between the edge servers and the data lake using advanced encryption modules to ensure data security.

In some arrangements, a computer-implemented process for optimizing data processing in a distributed network environment for a data lake system may comprise one or more steps such as, for example, receiving, at a plurality of edge servers, multinational data from various geographical locations, wherein each edge server is configured to preprocess the received data based on its respective geographical location characteristics; implementing distributed data cleansing at each edge server, wherein the data cleansing is adapted to local data characteristics of the respective geographical location, including but not limited to language, data format, and compliance standards; performing data deduplication at each edge server using algorithms tailored to the specific characteristics of the data from its geographical location, including fingerprinting techniques and delta encoding processes; standardizing the preprocessed data for language independence and regional compliance by applying machine translation, AI-driven attribute recognition, and data attribute normalization, thereby transforming the data into a standardized, language-independent format; utilizing a generative AI engine to autonomously generate data schema templates based on the standardized data, wherein the generative AI engine comprises algorithms including but not limited to Generative Pre-trained Transformer (GPT) and Transformer models, and wherein the data schema templates are configured to specify data storage formats, security protocols, data governance policies, metadata tagging, data transformation, and enrichment suitable for the data lake environment; in cases of data from mergers and acquisitions, dynamically integrating the data with existing organizational data structures using pre-deployed templates, and performing real-time data integration and instant data enrichment for non-conforming data, thereby ensuring seamless integration and continuity; implementing edge-based data routing and prioritization algorithms that prioritize data based on predefined configurations, including a hybrid geo-fencing algorithm for energy-efficient routing and AI-driven collaborative prioritization among edge devices; activating hyper ingestion of the prioritized and standardized data into the data lake environment, wherein the data lake is configured to store large quantities of raw data in its native format, and wherein the hyper ingestion is facilitated by the generative AI engine continuously optimizing the ingestion process based on live data characteristics; and providing live streaming data reports to business users based on the hyper ingested data, thereby enabling real-time insights and decision-making.

In various embodiments, the distributed data cleansing further includes removing redundant data entries based on unique digital fingerprints of each data item; the data deduplication at each edge server employs delta encoding techniques to store only unique attributes of data entities, reducing storage space and processing time; the machine translation in the standardization process is executed using a neural network-based translation model capable of handling multiple languages; the AI-driven attribute recognition involves using deep learning models to identify and categorize key data attributes relevant to the standardized format; the generation of data schema templates by the generative AI engine includes analyzing historical data patterns and ingestion frequencies to optimize the data ingestion process; the dynamic integration of merger and acquisition data includes reconciling disparate data structures and schemas between the acquiring and acquired entities; the edge-based routing and prioritization algorithms are configured to adaptively respond to network congestion and bandwidth availability in real-time; the hyper ingestion process includes a feedback mechanism that updates and refines the data schema templates based on the performance metrics of the ingestion process; and/or the live streaming data reports are customizable based on user preferences and are capable of providing summarizations of key data insights.

In various arrangements, processes may also include one or more steps of: adapting the standardization process based on the cultural and regulatory requirements specific to each geographical location from which the data originates, and/or encrypting the data during transmission between the edge servers and the data lake, utilizing advanced encryption protocols to ensure data security.

In some arrangements, a system for optimizing data processing in a distributed network environment for a data lake system may comprise one or more of: a plurality of edge servers, each configured to receive and preprocess data from various geographical locations, wherein each edge server includes mechanisms for distributed data cleansing adapted to local data characteristics and algorithms for data deduplication based on the geographical characteristics of the data; a generative artificial intelligence (AI) engine, communicatively connected to the edge servers, configured to autonomously generate data schema templates based on the preprocessed data, wherein the generative AI engine utilizes advanced algorithms including but not limited to Generative Pre-trained Transformer (GPT) and Transformer models; a data standardization module, integrated with the edge servers, designed to standardize the preprocessed data for language independence and compliance with regional regulations, including machine translation and AI-driven attribute recognition capabilities; a merger and acquisition data integration module, operatively connected to the edge servers, for dynamically integrating data from mergers and acquisitions using pre-deployed templates and real-time data integration techniques; an edge-based routing and prioritization system, operatively connected to the edge servers, configured to implement data routing and prioritization algorithms including hybrid geo-fencing and AI-driven collaborative prioritization for efficient data flow management; a hyper ingestion module, linked with the generative AI engine, for facilitating the ingestion of prioritized and standardized data into a data lake environment, wherein the hyper ingestion is continuously optimized based on live data characteristics; and a live data reporting interface, connected to the data lake, configured to provide business users with live streaming data reports based on the hyper ingested data, enabling real-time insights and decision-making.

In some arrangements, each of the edge servers includes a local data processing unit capable of performing real-time data validation and quality checks; the distributed data cleansing mechanism in the edge servers is further configured to employ adaptive filtering techniques based on the type of data and its source; the data deduplication algorithms include a configurable setting to adjust the deduplication aggressiveness based on data density and duplication patterns; the generative AI engine is further configured to continuously learn and adapt its data schema generation process based on feedback from the data lake ingestion results; the data standardization module employs a multilingual processing engine capable of translating and standardizing data from over fifty different languages; the merger and acquisition data integration module includes a data mapping tool that aligns divergent data formats and schemas from different entities; the edge-based routing and prioritization system uses a machine learning algorithm to optimize data flow based on network conditions and historical data traffic patterns; the hyper ingestion module includes a load balancing feature that distributes data processing loads across multiple data lake nodes to prevent bottlenecks; the live data reporting interface provides customizable dashboards that allow users to select specific data metrics and visualization styles; the edge servers are equipped with advanced encryption modules to ensure data security during transmission to the data lake; and/or the generative AI engine includes a user interface for manual adjustments and customizations of data schema templates by system administrators.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the processes of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a sample conceptual diagram showing sample interactions, interfaces, steps, functions, and components in accordance with one or more data-lake hyper ingestion aspects of this disclosure as they relate to optimization, generation, and standardization of data schema template(s) for hyper ingestion in data lake environment leveraging generative AI algorithms (GPT, Transformer, etc.) by analyzing contextual information about source, data region, edge network.

FIG. 2 depicts an architectural diagram showing sample interactions, interfaces, steps, functions, and components in accordance with one or more data-lake hyper ingestion aspects of this disclosure as they relate to optimization, generation, and standardization of data schema template(s) for hyper ingestion in data lake environment leveraging generative AI algorithms (GPT, Transformer, etc.) by analyzing contextual information about source, data region, edge network.

FIG. 3 depicts another sample architectural diagram showing sample interactions, interfaces, steps, functions, and components in accordance with one or more data-lake hyper ingestion aspects of this disclosure as they relate to optimization, generation, and standardization of data schema template(s) for hyper ingestion in data lake environment leveraging generative AI algorithms (GPT, Transformer, etc.) by analyzing contextual information about source, data region, edge network.

FIG. 4 depicts a sample flow diagram showing sample interactions, interfaces, steps, functions, and components in accordance with one or more data-lake hyper ingestion aspects of this disclosure as they relate to optimization, generation, and standardization of data schema template(s) for hyper ingestion in data lake environment leveraging generative AI algorithms (GPT, Transformer, etc.) by analyzing contextual information about source, data region, edge network.

### DETAILED DESCRIPTION

In the following description of the various embodiments to accomplish the foregoing, reference is made to the drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like (referenced interchangeably herein depending on context) can include one or more general-purpose, customized, configured, special-purpose, virtual, physical, and/or network-accessible devices as well as all hardware/software/components contained therein or used therewith as would be understood by a skilled artisan, and may have one or more application specific integrated circuits (ASICs), microprocessors, cores, executors etc. for executing, accessing, controlling, implementing etc. various software, computer-executable instructions, data, modules, processes, routines, or the like as explained below. References herein are not considered limiting or exclusive to any type(s) of electrical device(s), or component(s), or the like, and are to be interpreted broadly as understood by persons of skill in the art. Various specific or general computer/network/software components, machines, or the like are not depicted in the interest of brevity or discussed herein in detail because they are known and understood by ordinary artisans.

Software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Some or all the foregoing may additionally and/or alternatively be stored similarly and/or in a distributed manner in the network accessible storage/distributed data/datastores/databases/big data/blockchains/distributed ledger blockchains etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol.

The foregoing also includes edge network(s) and network edge(s), which refers to a distributed computing paradigm that brings computation and data storage closer to the location where it is needed, to improve response times and save bandwidth. The term “edge” in this context refers to the literal edge of the network, meaning the computing is done at or near the source of the data, rather than relying on a central data-processing warehouse far away. This approach is particularly beneficial for applications and services that require real-time or near real-time operations, as it minimizes latency—the delay before a transfer of data begins following an instruction for its transfer. In an edge network, the processing is done by edge nodes, which can be anything from a small server to a dedicated edge computing appliance, located close to the devices that generate or use the data. This setup is in contrast to traditional cloud computing, where data is typically sent to large, centralized cloud data centers for processing.

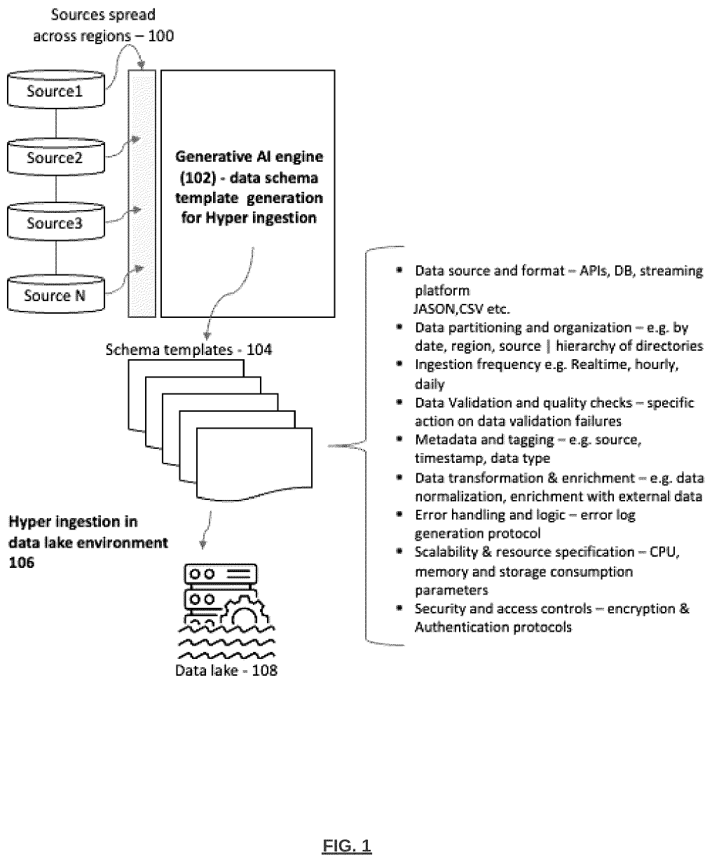

By way of non-limiting disclosure, FIG. 1 depicts a sample conceptual diagram showing sample interactions, interfaces, steps, functions, and components in accordance with one or more data-lake hyper ingestion aspects of this disclosure as they relate to optimization, generation, and standardization of data schema template(s) for hyper ingestion in data lake environment leveraging generative AI algorithms (GPT, Transformer, etc.) by analyzing contextual information about source, data region, edge network.

This diagram depicts a data processing architecture using a generative AI engine. Data from multiple sources spread across regions 100 (Source1 to Source N) is directed to the generative AI engine 102, which creates data schema templates 104 for hyper ingestion into a data lake environment 106. This process aims to standardize data into a consistent format suitable for analysis and storage. The standardized data then flows into a data lake 108, symbolized by the server stack and gear icon, indicating a repository for large quantities of raw data in its native format.

The data schema templates can specify data sources and formats. This can identify the origins of data such as APIs, databases, or streaming platforms, and the formats they come in, like JSON, CSV, etc.

The data schema templates can specify data partitioning and organization in order to, for example, provide data storage based on attributes like date, region, or source, such as in a hierarchical directory system or other desired structure.

The data schema templates can specify ingestion frequency. This can determine how often data is ingested, which could be in real-time or at set intervals (e.g., hourly, daily, etc.)

Data validation and quality checks for the data schema templates can be provided thereby outlining the procedures for data validation and the actions to take when data fails these checks.

Metadata and tagging for data schema templates can be utilized for implementing a system for labeling data with metadata such as source identifiers, timestamps, and data types.

Data transformation and enrichment for data schema templates can be performed for enhancing data by normalizing it or adding additional context from external sources.

Error handling and logic for data schema templates can be used for establishing protocols for logging errors that occur during data processing.

Scalability and resource specification can be provided for setting parameters for the consumption of CPU, memory, and storage resources.

Security and access controls can be specified for defining the security measures for data protection, including encryption, and authentication protocols.

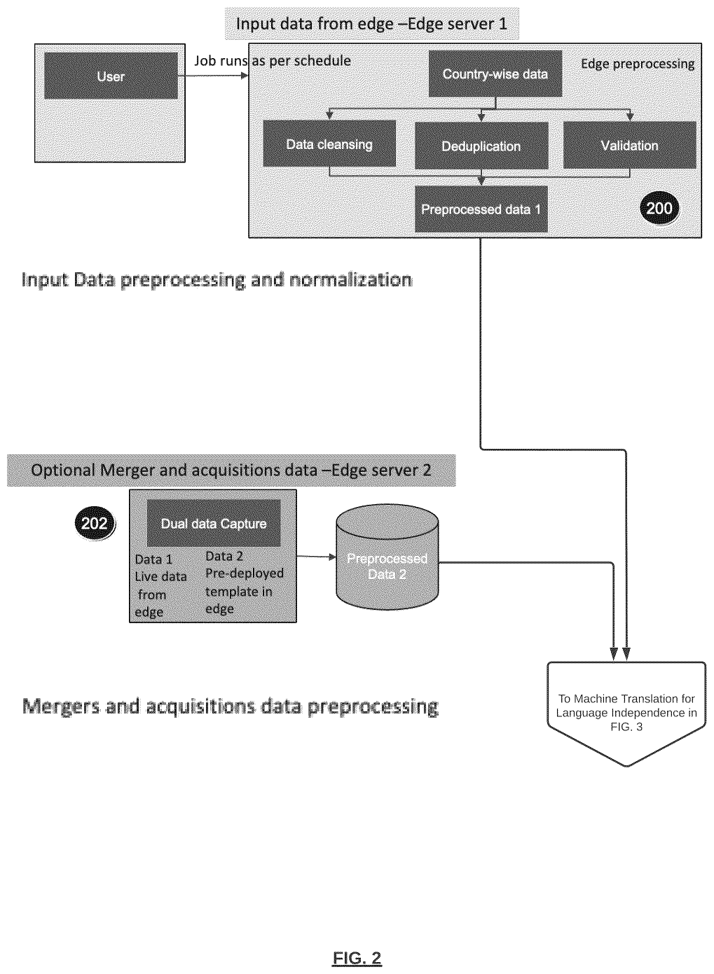

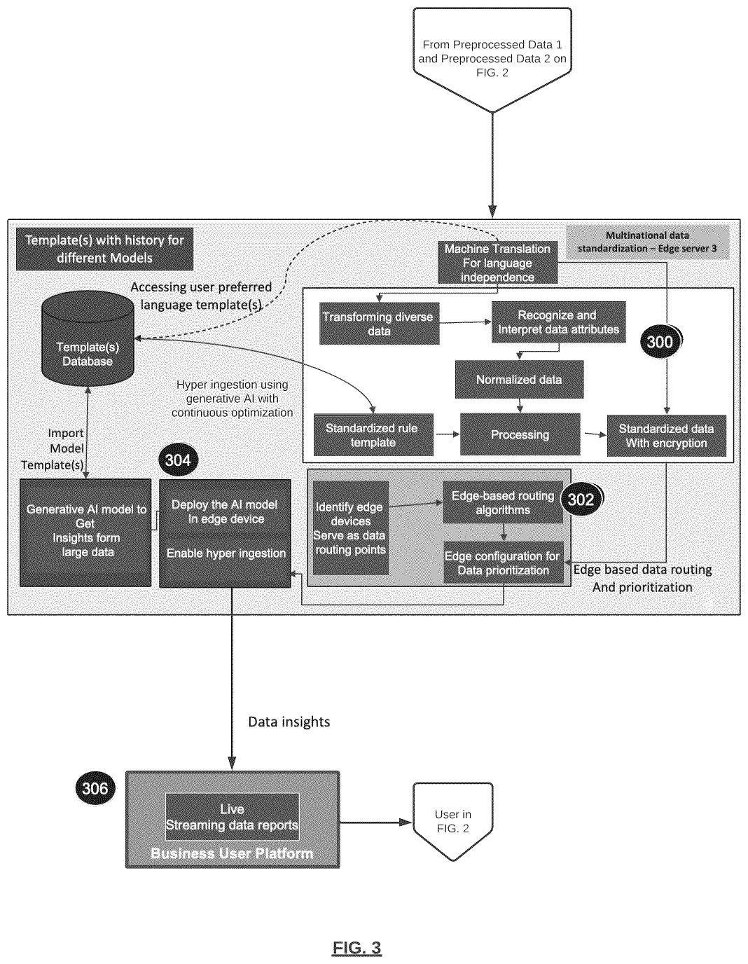

By way of non-limiting disclosure, FIGS. 2 and 3 depict architectural diagram(s) showing sample interactions, interfaces, steps, functions, and components in accordance with one or more data-lake hyper ingestion aspects of this disclosure as they relate to optimization, generation, and standardization of data schema template(s) for hyper ingestion in data lake environment leveraging generative AI algorithms (GPT, Transformer, etc.) by analyzing contextual information about source, data region, edge network.

FIGS. 2-3 illustrate a multi-layered data processing system that handles data through a series of interconnected stages.

Edge server preprocessing 200 is where user data enters the system and undergoes initial processing tasks such as cleansing and deduplication, ensuring data quality and uniqueness. The input data preprocessing stage is crucial for ensuring data quality and reducing latency, particularly when dealing with data from various countries stored in disparate databases. By implementing edge-based preprocessing, the system leverages distributed data cleansing which enhances data quality by processing it closer to its source, thereby reducing latency. An adaptive deduplication algorithm fine-tunes the deduplication process in response to different factors, optimizing data storage and retrieval. Preprocessing also considers geolocation, applying different optimization techniques tailored to each country's unique data characteristics. Quality assurance checks are performed at the edge level, establishing a localized approach to maintain data integrity. Additionally, the concept of global data quality is embodied through a network of edge servers, which allows for consistent validation standards across multiple countries, ensuring that data quality is maintained throughout the system regardless of the data's geographic origin.

Merger and Acquisition Data 202 identifies a secondary path is available for data from mergers and acquisitions, which is handled by the edge server and involves a dual data capture mechanism ensuring that live data and template-based data are processed in tandem. Merger and Acquisition (M&A) data preprocessing in the described system involves a dynamic integration process that aligns new data from acquisitions with the existing data structures of an organization. This process uses a real-time framework to automate data integration, leveraging pre-deployed templates. When M&A data does not fit the standard templates, it is enriched with existing organizational data for completeness. Metadata from M&A data is ingested and mapped to the organization's metadata system, ensuring dynamic tracking of data flow during the merger process. This approach allows for seamless data continuity and integrity throughout the integration phase.

For Multinational Standardization on edge server 300, at this stage, diverse data undergoes machine translation for uniformity in language, followed by attribute recognition and normalization to ensure a standardized format. The multinational data standardization process involves several advanced stages to ensure consistency and compliance across different systems and regions. Initially, edge servers preprocess data, which is then input for machine translation, guaranteeing language uniformity. AI is employed for identifying and standardizing attributes, contributing to a consistent output regardless of geographical origin. Data security is maintained through an encryption/decryption layer tailored to meet the legal demands of various countries. Furthermore, an automated normalization of data schemas aligns differing database structures into a singular, unified schema. This normalization accounts for discrepancies in naming conventions and structural differences. Lastly, standardization rules are not static; they are dynamically refined based on the contextual information provided by users, ensuring that the integrity and relevance of the data are maintained. This holistic approach underscores the system's adaptability and thoroughness in handling diverse multinational data sets.

Edge based data routing and prioritization is provided in 302. Post-standardization, the data is directed through edge-based routing algorithms that prioritize it based on predefined configurations. Hyper ingestion using generative AI with continuous optimization is shown in 304. A generative AI model is deployed within the edge device, which extracts insights from large data sets and facilitating the hyper ingestion process into the system. The edge-based data routing and hyper ingestion process, powered by generative AI, is a sophisticated mechanism that begins after data has been standardized. The routing algorithm considers geographical fencing parameters and energy consumption of edge nodes to efficiently direct data flow, significantly reducing energy usage and latency. AI algorithms analyze data in real time, enabling a coordinated response from multiple edge devices to assign data priority based on a collective strategy, ensuring that critical information is processed first. This process is personalized, with AI tailoring the ingestion of data streams to individual user patterns and preferences. The infrastructure is adaptive, using AI to adjust computing resources on the fly, ensuring optimal performance as data characteristics change. Key moments within the data are automatically highlighted and integrated into live streams, providing users with targeted and relevant information without the need to sift through the entirety of the data.

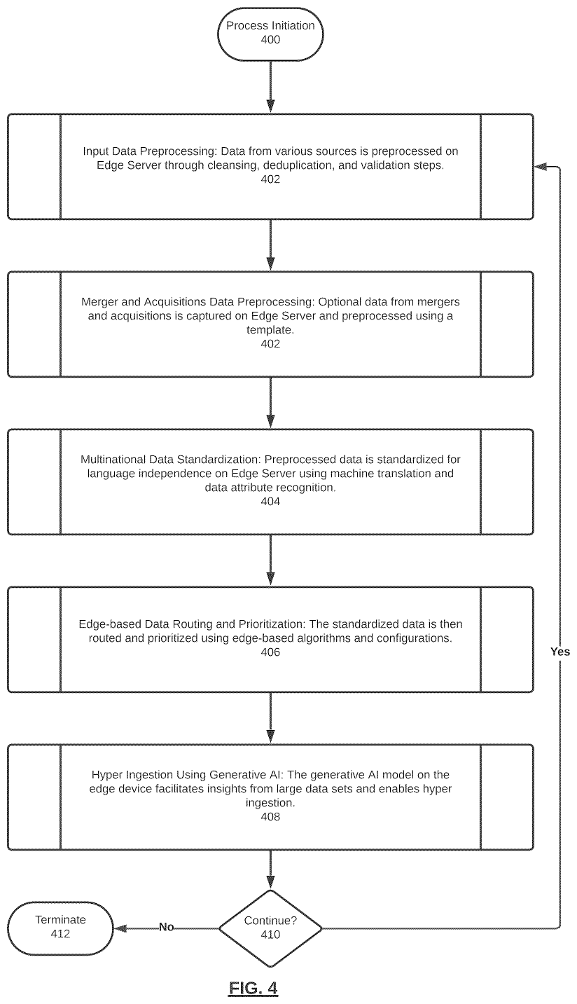

By way of non-limiting reference, FIG. 4 depicts a sample flow diagram showing sample interactions, interfaces, steps, functions, and components in accordance with one or more data-lake hyper ingestion aspects of this disclosure as they relate to optimization, generation, and standardization of data schema template(s) for hyper ingestion in data lake environment leveraging generative AI algorithms (GPT, Transformer, etc.) by analyzing contextual information about source, data region, edge network.

After process initiation in 400, input data preprocessing is performed in 402. Data from various sources is preprocessed on the edge server through cleansing, deduplication, and validation steps.

In merger and acquisitions data preprocessing 404, optional data from mergers and acquisitions is captured on the edge server and preprocessed using a template.

In multinational data standardization 406, preprocessed data is standardized for language independence on the edge server using machine translation and data attribute recognition.

In edge-based data routing and prioritization 408, standardized data is then routed and prioritized using edge-based algorithms and configurations.

In hyper ingestion using generative AI, the generative AI model on the edge device facilitates insights from large data sets and enables hyper ingestion.

Users interact with the system via a business platform that provides live streaming data reports for insights.

The system culminates in delivering processed, insightful data to business users through live streaming reports, enabling timely and informed decision-making.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer-implemented process for optimizing data processing in a distributed network environment for a data lake system, comprising the steps of:
receiving, at edge servers, multinational data from differing geographical locations, wherein said edge servers are configured with local data processing units that perform real-time data validation and quality checks;
implementing, at said edge servers, distributed data cleansing that is adapted to local data characteristics of the geographical locations, wherein the distributed data cleansing utilizes adaptive filtering techniques based on data type and source, and removes redundant data entries based on unique digital fingerprints;
performing, at said edge servers, data deduplication of the multinational data using algorithms tailored to specific characteristics of the multinational data corresponding to said geographical locations, including at least a fingerprinting technique and delta encoding process, and utilizes configurable settings for deduplication aggressiveness based on data density and duplication patterns;
standardizing at said edge servers, preprocessed data for language independence and regional compliance by applying machine translation and AI-driven attribute recognition capabilities, wherein the machine translation is executed using a neural network-based translation model capable of handling multiple languages, said preprocessed data standardized into standardized data;
utilizing a generative artificial intelligence (AI) engine, communicatively connected to the edge servers, to autonomously generate data schema templates based on the standardized data, wherein the generative AI engine is configured to continuously learn and adapt a data schema generation process based on feedback from data lake ingestion results;
dynamically integrating data from mergers and acquisitions using a merger and acquisition data integration module with a data mapping tool that aligns divergent data formats and divergent schemas from different entities, and performing real-time data integration and instant data enrichment for non-conforming data;
implementing edge-based routing and prioritization algorithms using a machine learning algorithm to optimize data flow based on network conditions, historical data traffic patterns, and a hybrid geo-fencing system for efficient data management;
facilitating hyper ingestion of the standardized data into the data lake environment using a hyper ingestion module with a load balancing feature, wherein the hyper ingestion is continuously optimized based on live data characteristics and includes a feedback mechanism that updates and refines the data schema templates based on performance metrics;
providing live streaming data reports based on the hyper ingestion through a live data reporting interface offering customizable dashboards, enabling real-time insights and decision-making; and
encrypting data during transmission between the edge servers and the data lake using encryption modules to ensure data security.

2. A computer-implemented process for optimizing data processing in a distributed network environment for a data lake system, the process comprising the steps of:
receiving, at a plurality of edge servers, multinational data from various geographical locations, wherein said edge servers are configured to preprocess the received data based on geographical location characteristics;
implementing distributed data cleansing at said edge servers, wherein the data cleansing is adapted to local data characteristics of the geographical locations including language, data format, and compliance standards;
performing data deduplication at said edge servers using algorithms tailored to specific characteristics of the multinational data from the geographical locations, including fingerprinting techniques and delta encoding processes;
standardizing preprocessed data for language independence and regional compliance by applying machine translation, AI-driven attribute recognition, and data attribute normalization, thereby transforming the multinational data into a standardized, language-independent format;
utilizing a generative AI engine to autonomously generate data schema templates based on the preprocessed data that was standardized, wherein the data schema templates are configured to specify data storage formats, security protocols, data governance policies, metadata tagging, data transformation, and enrichment suitable for a data lake environment;
in cases of data from mergers and acquisitions, dynamically integrating the multinational data with existing organizational data structures using pre-deployed templates, and performing real-time data integration and instant data enrichment for non-conforming data, thereby ensuring seamless integration and continuity;
implementing edge-based data routing and prioritization algorithms that prioritize the preprocessed data based on predefined configurations, including a hybrid geo-fencing algorithm for energy-efficient routing and AI-driven collaborative prioritization among said edge devices;
activating hyper ingestion of the preprocessed data that was prioritized and standardized data into the data lake environment that is configured to store large quantities of raw data in its native format, and wherein the hyper ingestion is facilitated by the generative AI engine continuously optimizing the ingestion process based on live data characteristics; and
providing live streaming data reports based on the hyper ingestion, thereby enabling real-time insights and decision-making.

3. The process of claim 2, wherein the distributed data cleansing further includes removing redundant data entries based on unique digital fingerprints of each data item.

4. The process of claim 3, wherein the data deduplication at said edge servers employs delta encoding techniques to store unique attributes of data entities, reducing storage space and processing time.

5. The process of claim 4, further comprising the step of adapting the standardization process based on the cultural and regulatory requirements specific to the geographical locations from which the multinational data originates.

6. The process of claim 5, wherein the machine translation in the standardization process is executed using a neural network-based translation model capable of handling multiple languages.

7. The process of claim 6, wherein the AI-driven attribute recognition involves using deep learning models to identify and categorize data attributes relevant to the standardized format.

8. The process of claim 7, wherein the generation of data schema templates by the generative AI engine includes analyzing historical data patterns and ingestion frequencies to optimize the data ingestion process.

9. The process of claim 8, wherein the dynamic integration of merger and acquisition data includes reconciling disparate data structures and schemas between the acquiring and acquired entities.

10. The process of claim 9, wherein the edge-based routing and prioritization algorithms are configured to adaptively respond to network congestion and bandwidth availability in real-time.

11. The process of claim 10, wherein the hyper ingestion process includes a feedback mechanism that updates and refines the data schema templates based on the performance metrics of the ingestion process.

12. The process of claim 11, wherein the live streaming data reports are customizable based on user preferences and are capable of providing summarizations of data insights.

13. The process of claim 12, further including a step of encrypting the data during transmission between the edge servers and the data lake, utilizing encryption protocols to ensure data security.

14. A system for optimizing data processing in a distributed network environment for a data lake system, comprising:
a plurality of edge servers configured to receive and preprocess multinational data into preprocessed data from various geographical locations, wherein said edge servers include mechanisms for distributed data cleansing adapted to local data characteristics and algorithms for data deduplication based on geographical characteristics of the data;
a generative artificial intelligence (AI) engine, communicatively connected to the edge servers, configured to autonomously generate data schema templates based on the preprocessed data, wherein the generative AI engine utilizes advanced algorithms including but not limited to Generative Pre-trained Transformer (GPT) and Transformer models;
a data standardization module, integrated with the edge servers, designed to standardize the preprocessed data for language independence and compliance with regional regulations, including machine translation and AI-driven attribute recognition capabilities;
a merger and acquisition data integration module, operatively connected to the edge servers, for dynamically integrating data from mergers and acquisitions using pre-deployed templates and real-time data integration techniques;
an edge-based routing and prioritization system, operatively connected to the edge servers, configured to implement data routing and prioritization algorithms including hybrid geo-fencing and AI-driven collaborative prioritization for efficient data flow management, in order to transform the preprocessed data that was standardized into prioritized and standardized data;
a hyper ingestion module, linked with the generative AI engine, for facilitating the ingestion of the prioritized and standardized data into a data lake environment, wherein hyper ingestion is continuously optimized based on live data characteristics; and
a live data reporting interface, connected to the data lake environment, configured to provide business users with live streaming data reports based on the hyper ingested data, enabling real-time insights and decision-making.

15. The system of claim 14, wherein each of the edge servers includes a local data processing unit capable of performing real-time data validation and quality checks.

16. The system of claim 15, wherein the distributed data cleansing mechanism in the edge servers is further configured to employ adaptive filtering techniques based on the type of multinational data and its source.

17. The system of claim 16, wherein the data deduplication algorithms include a configurable setting to adjust the deduplication aggressiveness based on data density and duplication patterns.

18. The system of claim 17, wherein the generative AI engine is further configured to continuously learn and adapt based on feedback results corresponding to ingestion into the data lake.

19. The system of claim 18, wherein the merger and acquisition data integration module includes a data mapping tool that aligns divergent data formats and schemas from different entities.

20. The system of claim 19, wherein:
the edge-based routing and prioritization system uses a machine learning algorithm to optimize data flow based on network conditions and historical data traffic patterns;
the hyper ingestion module includes a load balancing feature that distributes data processing loads across multiple data lake nodes to prevent bottlenecks;
the live data reporting interface provides customizable dashboards that allow user-selection of data metrics and visualization styles;
the edge servers are equipped with advanced encryption modules to ensure data security during transmission to the data lake environment; and
the generative AI engine includes a user interface for manual adjustments and customizations of the data schema templates.
